(19) United States
(12) Patent Application Publication
(10) Pub. No.: US 2012/0298022 A1
(43) Pub. Date: Nov. 29, 2012

(54) HIGH CAPACITY SLICE SEEDER

(76) Inventor: Ralph C. Bowen, Columbia, CT (US)

(21) Appl. No.: 13/479,932

(22) Filed: May 24, 2012

Related U.S. Application Data
(60) Provisional application No. 61/490,913, filed on May 27, 2011.

(51) Int. Cl. A01C 5/06

(52) U.S. Cl. 111/69; 111/14

(57) ABSTRACT

A slice seeder apparatus includes a frame supported on wheels, and ground-engaging blades housed in the frame. At least one of the wheels can be moved between a raised position and a lowered position with respect to the frame. The apparatus also includes a hoist for moving the at least one wheel between the raised position where the blades are engaged in the ground, and the lowered position where the blades are clear from the ground. Additionally, the apparatus includes an engine housed in the frame and operatively connected to power at least the blades and the hoist; and at least one switch for actuating the hoist to move between the raised position and the lowered position.

### CROSS REFERENCE TO RELATED APPLICATIONS

The present application claims the benefit under 35 USC §119(e) of Prov. App. 61/490,913 filed May 27, 2011, and incorporates by reference the disclosures thereof.

### BACKGROUND

1. Technical Field

The present invention relates to lawn care. Particular embodiments of the invention relate to machines and methods for seeding of turf.

2. Discussion of Art

Lawn care is a traditional aspect of urban and suburban home ownership, and is also important in commercial settings including office parks and golf courses. A key aspect of lawn care is the maintenance of a well-trimmed and weed-free appearance. Although regular mowing and periodic application of selective herbicides can be helpful in keeping a tidy appearance and in combating weed growth, the best method for ensuring lawn health is to encourage thick growth of desirable turf grass varieties (e.g., Bermuda grass, bentgrass, ryegrass, fescue, bluegrass, zoysia, or buffalo grass). In established lawns, where traffic or climate may have impaired the health of the existing turf, thick growth can be restored by aeration and overseeding of compatible new turf grass.

Conventionally, overseeding is done using self-propelled power seeders. For example, slice seeders may be used. A slice seeder is a particular type of power seeder that includes rotating blades that engage the ground for opening furrows, and seed tubes for dropping seeds into the opened furrows. The blades and tubes are mounted in a frame that is supported on rear wheels and front wheels. A combustion engine also is mounted on the frame for driving the blades and at least some of the wheels. Thus, slice seeders may be self-propelled. For example, Billy Goat Industries of Lee's Summit, Mo. sells self-propelled combination power rake and slice seeders (model numbers PR550, PR500, OS552, PR600, PR602) that are driven by gasoline engines via belts. Similarly, Schiller-Pfeiffer of Southampton, Pa. sells self-propelled combination turf rake and turf seeders (model numbers TRS-20, TSS-20) that are driven by gasoline engines via belts. Bluebird International of Beatrice, Nebr. sells self-propelled turf seeders (model number S-22) that are driven by gasoline engines via belts. John Deere of Landscapes of Alpharetta, Ga. sells Lesco Renovators (e.g., model number 20) that are driven by gasoline engines via belts.

Each of these conventional power seeders provides for manual adjustment of blade height. In order to steer any of these conventional power seeders, a user must push down on a rear handle, so as to disengage the rotating blades from the ground. Each of these conventional power seeders weighs in excess of one hundred thirty (130) pounds. Accordingly, those of ordinary skill will appreciate that the conventional method for steering a power seeder requires strenuous labor, and presents risks of injury from imbalance of the seeder and/or from exposure to spinning blades.

One known approach to minimize risks of tipping over a power seeder during turning is to minimize the weight (capacity) of a seed hopper. Conventional power seeders typically have seed hoppers limited to less than twenty five (25) pounds of grass seed; while Bluebird International's S-22 is marketed as having a “high capacity” hopper that can hold up to thirty (30) pounds of grass seed. Thus, conventional seed hoppers make up only about ten to twenty percent (10-20%) of the overall power seeder weight. One of ordinary skill will appreciate that further reductions of seed hopper capacity would present the unacceptable combination of requiring frequent seed refills (anywhere from once to four times per quarter acre (10,000 sq ft) of seeded land), while also failing to significantly improve steering characteristics. Meanwhile, one of ordinary skill also will appreciate that weight reductions to the operating mechanisms of the conventional power seeder would unacceptably detract from power, speed, cutting depth, durability, vibration resistance, and overall performance of the seeder.

Another approach is to make the cutting blades retractable within a frame of a slice seeder. For example, U.S. Pat. No. 4,821,655 granted to Rizzo discloses an array of slicing blades that are pivotally housed within a frame supported on four wheels. The array of blades can be forced downward into the ground by actuation of a toggle link. The toggle serves to hold the rotating blades in engagement with the ground.

Thus, it has long been felt desirable to provide a power seeder that includes a large capacity seed hopper, and a suitably sturdy operating mechanism, while also being convenient to steer without excessive physical effort.

### BRIEF DESCRIPTION

Thus, according to embodiments of the present invention, a slice seeder apparatus includes a frame supported on wheels, and ground-engaging blades housed in the frame. At least a forward pair of the wheels can be moved between a raised position and a lowered position with respect to the frame. The apparatus also includes a hoist for moving at least the forward pair of wheels between the raised position where the blades are engaged in the ground, and the lowered position where the blades are clear from the ground. Additionally, the apparatus includes an engine housed in the frame and operatively connected to power at least the blades and the hoist; and at least one switch for actuating the hoist to move between the raised position and the lowered position.

These and other objects, features and advantages of the present invention will become apparent in light of the detailed description of the best mode embodiment thereof, as illustrated in the accompanying drawings.

### DRAWINGS

FIG. 1 shows a left side perspective view of major components of a high capacity slice seeder, according to an embodiment of the present invention.

FIG. 2 shows a right side schematic view of the slice seeder shown in FIG. 1.

FIG. 3 shows a rear perspective view of a power takeoff arrangement of the high capacity slice seeder.

FIG. 4 shows a perspective view of operator controls of the high capacity slice seeder.

FIG. 5 shows a perspective view of a master hydraulics manifold of the high capacity slice seeder.

### DETAILED DESCRIPTION OF THE DRAWINGS

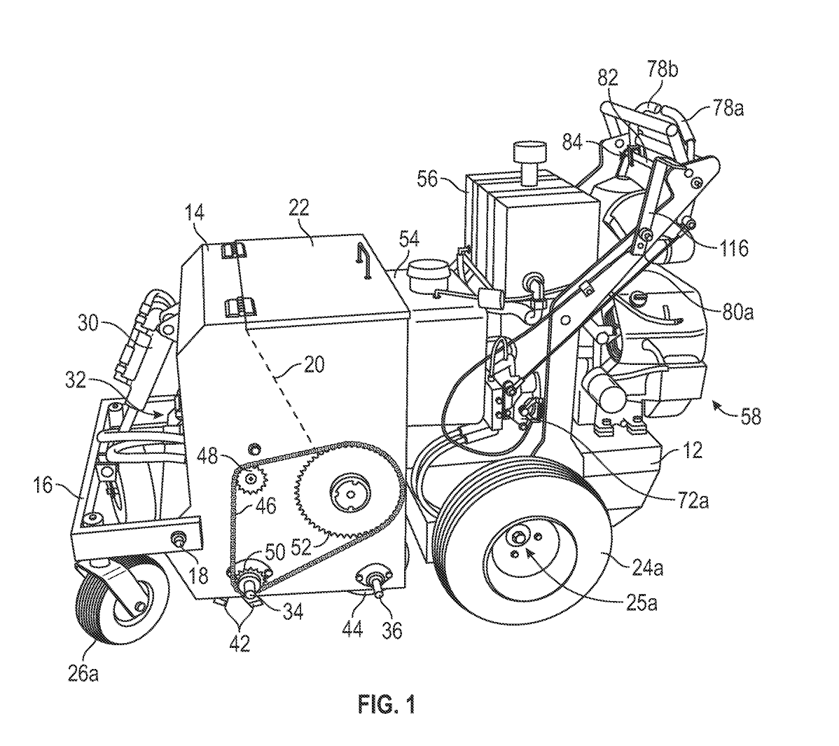

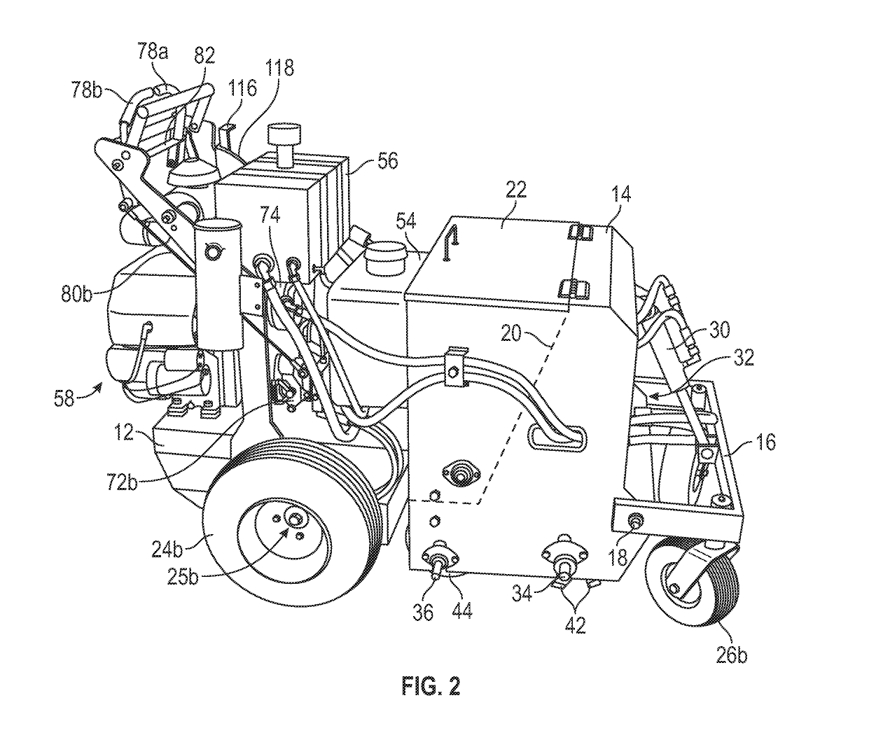

FIGS. 1 and 2 show a left side perspective view and a right side schematic of an slice seeder or slice seeding machine 10, according to an embodiment of the present invention. The inventive slice seeder includes a frame 12, a chassis or casing 14 mounted to a forward portion of the frame, and a caster bar 16 pivotally mounted to the chassis at forwardly-disposed caster pivots 18. The casing houses a large seed hopper 20, which is covered by a seed hopper lid 22 at the top of the casing. Any conventional arrangement is provided for efficiently transferring grass seed (or other seeds) from the seed hopper into the ground beneath the slice seeder.

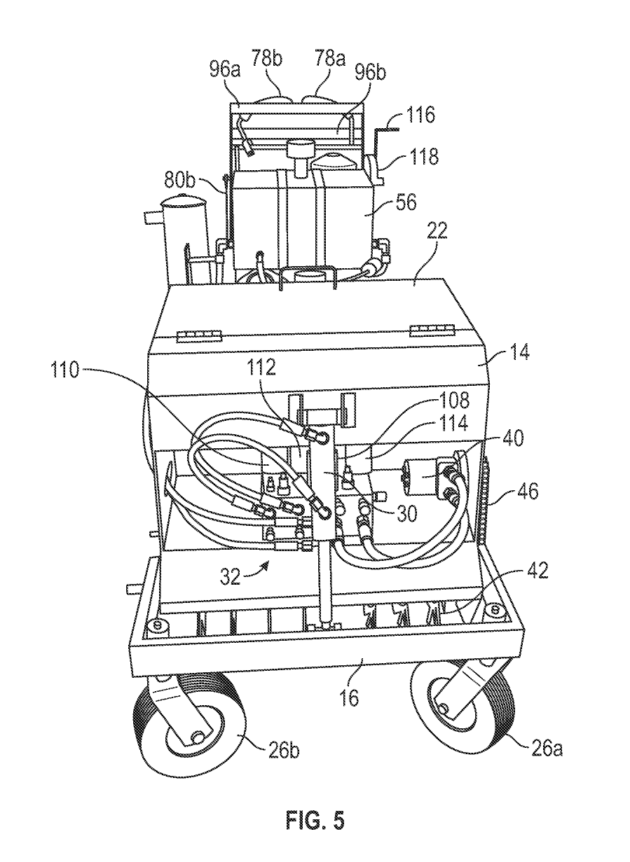

The frame, casing, and caster bar are supported on drive wheels 24 and on caster wheels 26. The left and right drive wheels 24a, 24b are rotatably mounted to the frame via respective left and right hydraulic wheel motors 25a, 25b. The casters are pivotally mounted to the caster bar 16 via axles 28. The caster bar can be rotated about its pivots by actuation of a hoist 30. In the illustrated embodiment, the hoist 30 is a hydraulic ram that is provided with hydraulic fluid via a PTO control valve manifold 32, as further discussed below with reference to FIG. 5. In addition to the caster bar 16, the casing supports several rotating components: a blade shaft 34, a harrow shaft 36, a seed agitator 38 that is mainly housed within the seed hopper, and a PTO motor 40 (shown in FIG. 5). The blade shaft supports an array of slicing blades 42. The harrow shaft supports an array of discs 44 in line with the slicing blades.

During operation of the slice seeder, the PTO drive motor 40 can be provided with hydraulic fluid via the PTO control valve manifold 32, as further discussed below. When powered, the PTO drive motor drives the blade shaft 34 and the seed agitator 38 via a drive chain 46, which engages sprockets 48, 50, 52 respectively connected to the PTO drive motor 40, to the blades shaft 34, and to the seed agitator 38. The slicing blades 42 cut furrows in the ground, while the seed agitator feeds grass seed from the seed hopper 20 downward to the harrow discs 44. The harrow shaft 36 is not necessarily powered, so the discs can spin freely in the furrows cut by the slicing blades.

Rearward of the casing or chassis, a fuel tank 54 is mounted on the frame. Above and rearward of the fuel tank, a hydraulic reservoir 56 is mounted. Rearward of the hydraulic reservoir, an engine 58 is mounted on the frame. In some embodiments the engine is a Kohler Model No. ECH730 with an integral fuel pump.

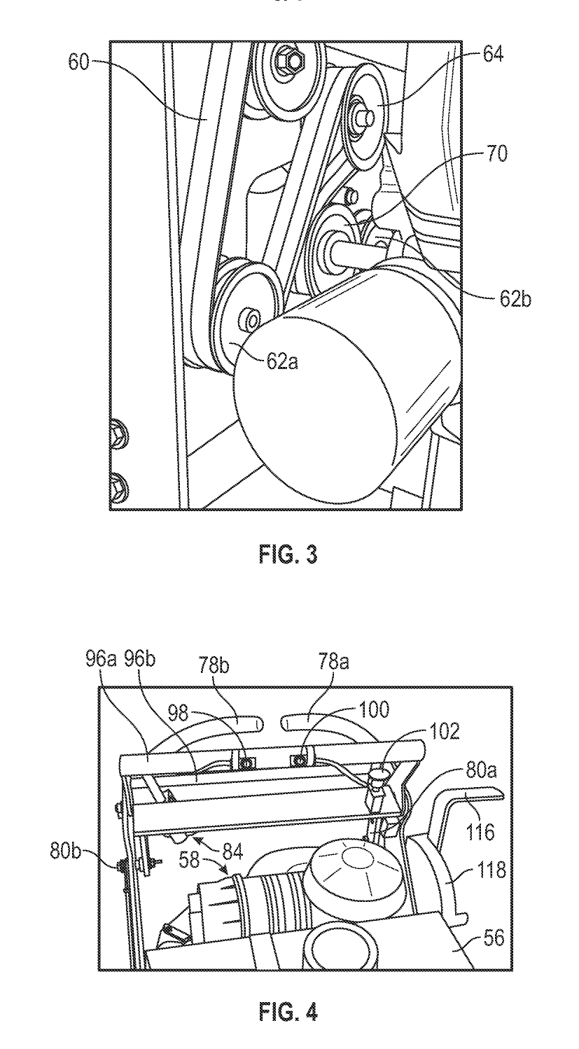

FIG. 3 shows that below the hydraulic reservoir, and between the fuel tank and the engine, a transversely oriented drive belt 60 engages a drive pulley 70 that is mounted on the shaft of the engine 58. The drive belt transfers power from the engine shaft to three pulleys 62a, 62b, 64. Each of these three pulleys drives a corresponding hydraulic pump 72a, 72b, or 74. Each pump is supplied with fluid from the hydraulic reservoir 56 mounted above the engine. The hydraulic pumps include a left steering pump 72a, a right steering pump 72b, and a PTO (power takeoff) pump 74.

Each steering pump 72a, 72b powers the wheel motor 25 that drives the drive wheel 24 on the same side. Each steering pump 72 is a “return to neutral” pump. These return-to-neutral pumps include an integrated directional valve that is spring-loaded to vent the pump discharge back to the reservoir 56, and that can be positioned to direct the pump discharge to one or more outlets of the valve. In embodiments of the invention, each steering pump has a forward and a reverse outlet in addition to the neutral vent. From each steering pump, hydraulic lines bring fluid to and from the associated wheel motor.

The PTO pump 74 is an “always on” pump that continuously provides hydraulic fluid to the hoist 30 and to the PTO motor 40 through the control valve manifold 32 mounted in the forward part of the chassis, as further discussed below with reference to FIGS. 4 and 5.

FIG. 4 shows operator controls 76 for the engine 58, the hydraulic pumps 72a, 72b, 74, and the control valve manifold 32. The control valve manifold, in turn, actuates the hoist 30 and the PTO/blade drive motor 40.

The operator controls include left and right drive handles or steering handles 78a, 78b, which are mechanically connected with the return-to-neutral valves of their respective steering pumps 72a, 72b via left and right steering linkages 80a, 80b. The left and right steering handles are pivotally mounted on a generally horizontal control axle. Pushing forward one of the steering handles 78 actuates the associated steering linkage 80 and steering pump 62, thereby directing hydraulic fluid to cause forward rotation of the corresponding drive wheel motor 25. Pulling back on one of the steering handles actuates the corresponding steering linkage and steering pump to cause rearward rotation of the corresponding drive wheel motor. Accordingly it is possible to achieve a substantially “zero radius” turn. Other combinations of wheel motor motion will be appreciated by those of ordinary skill.

The left steering handle is directly pivoted from the control axle via a simple tube. By contrast, the right drive handle is mounted to the control axle via an operator presence assembly 84, which includes a safety pivot, a spring that biases the right drive handle upwards about the safety pivot, and an operator presence disconnect. Unless an operator holds down the right drive handle toward the control axle, the spring biases the right drive handle so that a lower extension of the handle actuates the operator presence disconnect, which interacts with the PTO control valve manifold 32 to prevent hydraulic fluid being sent to the PTO/blade motor 40 or to the hoist 30. In embodiments, the operator presence disconnect does not open circuit the engine 58 ignition, thus, it is possible to keep the slice seeder 10 running without operating any of its powered components.

Front and rear stop bars 96a, 96b are provided as stops for the steering handles, to prevent excessive wheel speeds. The steering pumps and linkages generally bias the steering handles to neutral (zero-speed) positions about the control axle. Also, when biased by the spring to its upward position on the operator presence assembly 84, the right steering handle 78b engages into a notch that holds the steering handle at its “neutral” position.

In order to easily turn a slice seeding machine, it is necessary to raise the slicing blades and harrow discs out of the soil.

Accordingly, the operator controls 76 also include a hoist raise switch 98 that is mounted to the front handlebar just forward of the right steering handle, a hoist lower switch 100 that is mounted to the front handlebar just forward of the left steering handle, and a PTO engagement switch 102 that is mounted (along with an hour meter 104) on a controls and indicators bracket 106, which is disposed forward of the forward handle stop bar 96a. Each of these switches interacts with the PTO control valve manifold 32.

Specifically, the PTO engagement switch 102, when pulled out to an “engaged” position, activates a spring-return master solenoid 108 of the PTO control valve manifold to permit pressurized fluid to flow from the PTO pump 64 through a master valve and into the control valve manifold. When the master solenoid is not activated, the master valve defaults to a “bypass” position that simply sends fluid from the PTO pump back to the hydraulic reservoir 56.

The PTO engagement switch 102 includes a timer (not shown), so that if the operator presence disconnect is actuated, the PTO engagement switch must be pushed in or “disengaged”, and then “re-engaged”, before the PTO control valve manifold master solenoid 108 may again be activated.

Referring to FIG. 5, the raise and lower switches 98, 100 respectively activate raise 110 and lower 112 solenoids of the PTO control valve manifold 32. The raise solenoid or the lower solenoid alternately send pressurized hydraulic fluid from the PTO control valve to a raise fitting or to a lower fitting provided on the hoist 30. When neither switch is activated, both solenoids are spring-biased to closed positions, thereby locking the hoist. Thus, the hoist is “power up, power down”. In some embodiments, an electronic interlock (not shown) is provided, for example, within the PTO manifold 32, to prevent simultaneous activation of the raise and lower solenoids.

The caster bar 16 is pivotally connected to the forward end of the chassis 14, and is movable relative to the chassis by the hydraulic hoist 30. Extending the hoist, by pressurizing its raise fitting, pivots the caster bar downward, thereby hoisting the casing 14 and the blades 42 away from the ground. Retracting the hoist, by pressurizing its lower fitting, pivots the caster bar upward, thereby lowering the casing and the blades toward the ground so that the blades engage the ground. Because the blades 42 are mounted directly in the casing, thus, while engaged with the ground, the blades 42 support a part of the weight of the machine 10, which helps to maintain blade engagement.

In some alternate embodiments it is possible that actuation of the raise switch 98 may actuate the master solenoid 108 to cause the PTO master valve to divert fluid from the PTO drive motor 40, thereby stopping the blades 42 and agitator 38, while simultaneously extending the hoist to raise the chassis 14. In these embodiments, actuation of the lower switch 100 will restart the PTO drive motor while also retracting the hoist 30 to lower the chassis. It should be noted that the slicing blades can take significant time to “spin up” or “spin down”, even when clear of the ground, thus, the more complex alternate control scheme is not presently preferred.

In some embodiments, the slicing blades may be changed out for a spiked aerator roll (not shown) that is passively driven by the wheel motors. In these embodiments, provision of the hoist again permits for turning the hydraulically operated aerator without undue physical exertion.

In some embodiments, an electrical actuator such as a jack screw or servo may be substituted for the hoist 30. In this case the engine 58 would drive at least one electrical machine, such as a generator or an alternator, for powering the electrical actuator. Although electrical motors could equally be substituted for the hydraulic wheel motors 25, hydraulics presently are preferred for superior torque and thermal performance. In another embodiment, an entirely mechanical lever linkage may be substituted for the hoist 30, a switch handle of the linkage still being operable from the rearward end of the seeder by an operator concurrently steering the seeder. However such an embodiment has the drawback that the operator would have to move the entire weight of the high capacity slice seeder, exerting significant physical effort to do so.

The operator controls also include a seed gate handle 116 and a seed gate position gauge 118, which interact with the seed agitator 38 to adjust distribution of seed to the harrow discs 44. Thus, the drive wheel motors, the slicing blades and seed agitator, the hoist, and the flow of seeds downward from the hopper may be adjusted by operation of these controls.

Thus, embodiments of the invention provide a walk behind slice seeding machine or slice seeder for the seeding of turf grass in residential and commercial lawns. A walk behind slice seeding machine according to embodiments of the present invention is self propelled with hydraulic pumps and drives powered by an internal combustion engine. The walk behind apparatus is distinguished from larger ride-on or towed seeders by lower weight, lower cost, and greater efficiency of operation. By contrast to larger seeders designed for commercial turf farms, walk behind machines are suitable for use on smaller properties such as residential lawns or golf course greens. During steering, the ground-engaging blades of the walk behind slice seeder are raised out of the ground by a hoist, in contrast to requiring an operator to push down on the rearward end of the machine. This not only allows for virtually effortless operation, but also improves accuracy and stability of steering. Also, by eliminating the need to physically lift and turn, the inventive slice seeder enables use of a high capacity seed hopper, which in a prototype embodiment can hold up to about fifty (50) pounds of grass seed. The high capacity seed hopper thus enables sowing up to about a half acre (20,000 sq ft) without pausing to refill the hopper.

Although this invention has been shown and described with respect to the detailed embodiments thereof, it will be understood by those skilled in the art that various changes in form and detail thereof may be made without departing from the spirit and the scope of the invention.

What is claimed is:

1. A slice seeder apparatus comprising:
a frame supported on wheels, at least one of said wheels can be moved between a raised position and a lowered position with respect to said frame;
a plurality of ground-engaging blades housed in the frame;
a hoist connected between the frame and the at least one wheel for moving the at least one wheel between the raised position where the blades are engaged in the ground, and the lowered position where the blades are clear from the ground;
an engine housed in the frame, said engine operatively connected to power at least the blades and the hoist; and
at least one switch for actuating the hoist to move the at least one wheel between the raised position and the lowered position.

2. A slice seeder apparatus as claimed in claim 1, wherein said apparatus is a walk behind apparatus and the at least one switch is operable by an operator while walking and steering said apparatus.

3. A walk behind slice seeder apparatus as claimed in claim 2, the engine driving at least one hydraulic pump in hydraulic fluid communication with a plurality of hydraulic motors for powering at least the blades and the hoist.

4. A walk behind slice seeder apparatus as claimed in claim 3, said apparatus further comprising a first steering valve connected in hydraulic fluid communication between the at least one hydraulic pump and at least one wheel motor, and at least one handle connected for controlling said first steering valve.

5. A walk behind slice seeder apparatus as claimed in claim 4, the first steering valve being integrated into the at least one hydraulic pump.

6. A walk behind slice seeder apparatus as claimed in claim 4, the at least one switch being mounted adjacent the at least one handle.

7. A walk behind slice seeder apparatus as claimed in claim 4, said apparatus further comprising an operator presence disconnect for preventing unguided operation of said apparatus.

8. A slice seeder apparatus as claimed in claim 1, the engine driving at least one electrical machine for powering at least one of the blades or the hoist.

9. A slice seeder apparatus as claimed in claim 1, the at least one switch including a raise switch and a lower switch.

10. A method of steering a walk behind slice seeder having ground-engaging blades supported on wheels, said method comprising:
actuating a hoist to move at least one of said wheels for disengaging said blades from the ground; and
steering said walk behind slice seeder with all of said wheels remaining on the ground.

11. A method as claimed in claim 10, wherein actuating a hoist includes operating a switch mounted at a handlebar of said walk behind slice seeder.

12. A method as claimed in claim 10, wherein actuating a hoist includes causing the hoist to pivot downward at least one of said wheels, relative to said walk behind slice seeder.

13. A method as claimed in claim 10, further comprising, after steering, actuating the hoist to re-engage said blades into the ground.

14. A method as claimed in claim 10, further comprising, during steering, halting motion of said blades.
